(19) United States
(12) Patent Application Publication
(10) Pub. No.: US 2006/0198390 A1
(43) Pub. Date: Sep. 7, 2006

(54) Information processing apparatus, information processing method, and program

(75) Inventor: Hiroki Shouno, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/360,473

(22) Filed: Feb. 24, 2006

(30) Foreign Application Priority Data
Mar. 7, 2005 (JP) 2005-063153

(51) Int. Cl. H04L 12/56; H04L 12/28; H04J 3/16; H04J 3/22

(52) U.S. Cl. 370/466; 370/389; 370/401

(57) ABSTRACT

A purpose of this invention is to allow proper communication between two or more local networks. An information processing apparatus (101) which is connected to a first local network (105) and second local network (104) generates the first IP address for the first local network (105) and the second IP address for the first local network (105), that are not being used in the second local network (104). The information processing apparatus determines the first IP address as an IP address of an external control device (102) on the side of the first local network. The information processing apparatus assigns the second IP address to a node on the first local network.

### FIELD OF THE INVENTION

The present invention relates to an information processing apparatus connected between local networks, an information processing method using the apparatus, and an information processing program.

### BACKGROUND OF THE INVENTION

It is of general knowledge that technique to manage the address of a node belonging to a local network exist. For example, in an IP (Internet Protocol) network environment, a connection technique using a router (default gateway) is proposed as a technique to connect different network addresses. The router incorporates a table called a routing table, determines the transmission direction of a received IP packet, and transfers the packet to a proper network. For example, when node A belonging to IP network A is to IP-communicate with node B belonging to IP network B, nodes A and B cannot directly communicate with each other because the network addresses of IP networks A and B are different from each other. In this case, the router sets the destination IP address of a packet to be sent from node A as the address of node B, and designates the MAC address of the router as a destination MAC address. Upon reception of the packet, the router refers to its routing table, and transfers the packet to network B. The packet transferred to network B reaches node B, completing data transmission.

There also exist routers equipped with a DHCP server function, which can assign IP addresses (see, e.g., Japanese Patent Laid-Open No. 2002-217941).

In today's Internet environment, LANs (Local Area Networks) are constructed in offices and houses. The IP address of a node connected to each LAN uses an address range called private addresses. The private address range is a set of IP addresses which one can freely use in his network environment, and which is defined to a different value than the global address used for the Internet. The LAN and Internet are connected by a router. When a node on the LAN is connected to a Web server or the like on the Internet, the private address undesirably leaks to the Internet. For the sake of security, a router which connects the LAN to the Internet allows the connection of a node on the LAN to the Internet, but generally inhibits routing from the Internet to the LAN. For this reason, if a private address leaks to the Internet, communication itself fails.

In order to avoid this problem, there exit a network routing technique called NAT (Network Address Translation) or NAPT (Network Address Port Translation). According to NAT, when a node on the LAN is to communicate with a node on the Internet, the router which connects the LAN and Internet rewrites the source IP address of a packet to the global address of the router. This processing can prevent leakage of a private address contained in a packet sent from a node on the LAN to the Internet. Since the source IP address of the packet becomes the Internet IP address of the router, a destination node on the Internet can respond to the packet. Then, upon reception of the response packet, the router transfers it to the node on the LAN.

In today's network devices, device modules are often connected via an IP communication network. In a system where a set of devices implements multiple functions, the devices themselves sometimes perform IP communication, in addition to the respective devices modules. In this case, network addresses used by devices and those used in an office LAN may totally or partially overlap with each other, obstructing communication between these different networks.

For example, an information processing apparatus is proposed, which expands the functions of a device (e.g., a multi-functional peripheral or printer) connected to a network. In this case, the information processing apparatus and the multi-functional peripheral or printer are connected via Ethernet to build a local network. In the local network, the multi-functional peripheral or printer and the information processing apparatus have predetermined private IP addresses to perform IP communication. According to the current technique, IP addresses and subnet masks used by these devices are permanently assigned and cannot be changed. The information processing apparatus has a function to perform NAT processing. The NAT processing function is used when the multi-functional peripheral or printer is to communicate with a node on the office LAN. That is, the information processing apparatus executes NAT processing for an IP packet sent from the multi-functional peripheral or printer, rewrites the IP address, and then transfers the packet to a node on the office LAN.

In this case, the two network addresses below may totally or partially overlap each other:
a network address containing a private IP address used in the local network to which the information processing apparatus and multi-functional peripheral are connected, and
a network address containing a private IP address used in the office LAN.

When these network addresses totally or partially overlap each other, a conflict occurs in the routing table of the information processing apparatus which performs NAT processing, causing a failure during transfer processing. Assume that the IP addresses and the subnet mask used in the local network are as follows.
IP address of the information processing apparatus: 192.168.0.1
IP address of the multi-functional peripheral: 192.168.0.2
Subnet mask: 255.255.255.0
The network address of the local network is 192.168.0.0. The network address used in the office LAN takes a value “192.168.0.0”.

In this case, the information processing apparatus registers the same network address for the local network and office LAN. For example, when the information processing apparatus is to transmit data to 192.168.0.4, it cannot determine to which of either the local network or the office LAN the data is to be transmitted. As a result, the information processing apparatus cannot determine any transfer route when routing packets. Since the local network and office LAN use private IP addresses, as described above, their IP address ranges are restricted and may overlap each other. An IP address used in the office LAN is usually managed by the LAN administrator, and is difficult to change. A local IP address is permanent and cannot be changed, as described above.

According to some techniques, IP addresses and related information which are used in local networks could be automatically distributed using an Auto IP protocol called DHCP. A typical example is a broadband router used in a home LAN or the like. The broadband router routes, to the Internet, a node connected to the home LAN. Routing generally uses NAT. The broadband router can use the DHCP protocol to distribute an IP address and related information to a node in the home LAN. However, no technique to prevent address overlapping is proposed because an IP network used within a home LAN and the one used within the Internet do not overlap. The home LAN uses private IP address, whereas the Internet uses different IP addresses than the private IP addresses. Hence, an IP address distributed by DHCP is either manually set by the user of the broadband router, or automatically assigned within the range of a private IP addresses by the broadband router. That is, the above-mentioned problems cannot be completely solved even if the technique used in the broadband router is exploited into the information processing apparatus.

### SUMMARY OF THE INVENTION

The present invention has been devised to overcome the conventional drawbacks, and has as its object to provide a technique capable of properly performing communication between two or more local networks.

In order to achieve the above object, an information processing apparatus according to the present invention comprises the following arrangement. That is, an information processing apparatus interposed between a first network and a second network, comprising:

address generating unit configured to generate a first address for the first network and a second address for the first network which are not in use in the second network;

first address setting unit configured to set the first address as an address of the information processing apparatus for the first network; and

second address setting unit configured to assign the second address to a node on the first network.

Another information processing apparatus according to the present invention comprises the following arrangement. That is,

an information processing apparatus interposed between a first network and a second network, comprising:

address converting unit configured to convert an address of a network packet when a node on the first network is to communicate with a node on the second. network;

address recognizing unit configured to recognize an address and subnet mask of the information processing apparatus for the second network;

address generating unit configured to generate, on the basis of the address and the subnet mask recognized by the address recognizing unit, a first address for the first network and a second address for the first network which are not in use in the second network;

determining unit configured to determine whether the first address and the second address are in use in the second network and a third network connected to the second network via a router;

first address setting unit configured to set the first address as an address of the information processing apparatus for the first network when the determining unit determines that the first address is not in use; and

second address setting unit configured to assign the second address to a node on the first network when the determining unit determines that the second address is not in use.

In order to achieve the above object, an information processing method according to the present invention according to the present information comprises the following arrangement. That is,

an information processing method executed in an information processing apparatus interposed between a first network and a second network, comprising:

an address generating step of generating a first address for the first network and a second address for the first network which are not in use in the second network;

a first address setting step of setting the first address as an address of the information processing apparatus for the first network; and

a second address setting step of assigning the second address to a node on the first network.

Another information processing method according to the present invention comprises the following arrangement. That is,

an information processing method executed in an information processing apparatus interposed between a first network and a second network, comprising:

an address recognizing step of recognizing an address and subnet mask of the information processing apparatus for the second network;

an address generating step of generating, on the basis of the address and the subnet mask recognized in the address recognizing step, a first address for the first network and a second address for the first network which are not in use in the second network;

an address determining step of determining whether the first address and the second address are in use in the second network and a third network connected to the second network via a router;

a first address setting step of setting the first address as an address of the information processing apparatus for the first network when the first address is determined in the address determining step not to be in use;

a second address setting step of assigning the second address to a node on the first network when the second address is determined in the address determining step not to be in use; and

an address converting step of converting an address of a network packet when a node on the first network is to communicate with a node on the second network by using the first address and the second address.

In order to achieve the above object, an information processing program according to the present invention comprises the following arrangement. That is,

an information processing program for controlling an information processing apparatus interposed between a first network and a second network, causing the information processing apparatus to execute

an address generating step of generating a first address for the first network and a second address for the first network which are not in use in the second network,

a first address setting step of setting the first address as an address of the information processing apparatus for the first network, and

a second address setting step of assigning the second address to a node on the first network.

Another information processing program according to the present invention comprises the following arrangement. That is,

an information processing program for controlling an information processing apparatus interposed between a first network and a second network, causing the information processing apparatus to execute

an address recognizing step of recognizing an address and subnet mask of the information processing apparatus for the second network,

an address generating step of generating, on the basis of the address and the subnet mask recognized in the address recognizing step, a first address for the first network and a second address for the first network which are not in use in the second network,

an address determining step of determining whether the first address and the second address are in use in the second network and a third network connected to the second network via a router,

a first address setting step of setting the first address as an address of the information processing apparatus for the first network when the first address is determined in the address determining step not to be in use,

a second address setting step of assigning the second address to a node on the first network when the second address is determined in the address determining step not to be in use, and

an address converting step of converting an address of a network packet when a node on the first network is to communicate with a node on the second network by using the first address and the second address.

According to the present invention, communication between two or more networks can be appropriately performed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of the connection configuration of a system according to an embodiment of the present invention;

FIG. 2 is a block diagram showing the internal structure of an external control device;

FIG. 3 is a block diagram showing the internal structure of an image processing apparatus;

FIG. 4 is a block diagram showing the software configuration of the external control device:

FIG. 5 is a block diagram showing the software configuration of the image processing apparatus;

FIG. 6 is a view showing data contents in NAT processing;

FIG. 7 is a view showing a port assignment structure in the external control device;

FIG. 8 is a flowchart showing processing flows by respective devices in determining a local address;

FIG. 9 is a flowchart showing processing flows by respective devices after determining a local address;

FIG. 10 is a view showing an example of the panel UI (User Interface) of the image processing apparatus when a local address becomes invalid; and

FIG. 11 is a flowchart showing a flow when the external control device acquires an IP address by DHCP.

### DETAILED DESCRIPTION OF THE PREFERRED: EMBODIMENTS

Preferred embodiments of the present invention will now be described in detail in accordance with the accompanying drawings.

### First Embodiment

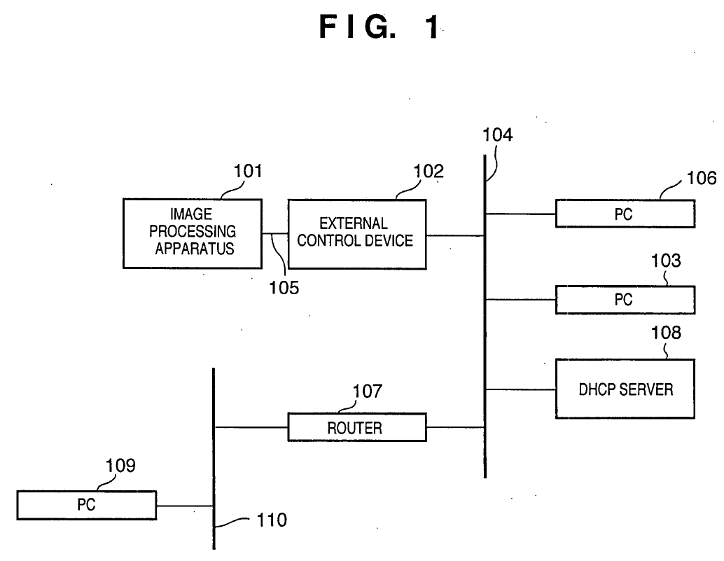

An external control device according to the first embodiment of the present invention will be described with reference to the accompanying drawings. A network system to which the external control device can be applied will be explained with reference to FIG. 1. PCs 103 and 106 are connected to a user environment network 104, and an external control device 102 and DHCP server 108 are further connected to it. A router 107 is connected to the network 104 and a network 110, and performs network routing. A PC 109 is connected to the network 110. The external control device 102 is also connected to a local network 105 different from the network 104, and an image processing apparatus 101 is connected to the local network 105. Assume that the network 104, local network 105, and network 110 are based on Ethernet®. The external control device 102 is an information processing apparatus which is connected to the local network 105 serving as the first local network and the local network 104 serving as the second local network.

The image processing apparatus 101 is a multi-functional peripheral with scanner, copy, and printer functions. The image processing apparatus 101 performs various network communication operations in executing the functions of the multi-functional peripheral. For example, the image processing apparatus 101 has a function of storing, in a server on the network, an image read by the scanner of the image processing apparatus 101. The DHCP server 108 is implemented by installing, in PC-based hardware, software for operating a DHCP server (Dynamic Host Configuration Protocol server). The DHCP server 108 uses a DHCP protocol to execute network configuration to a host.

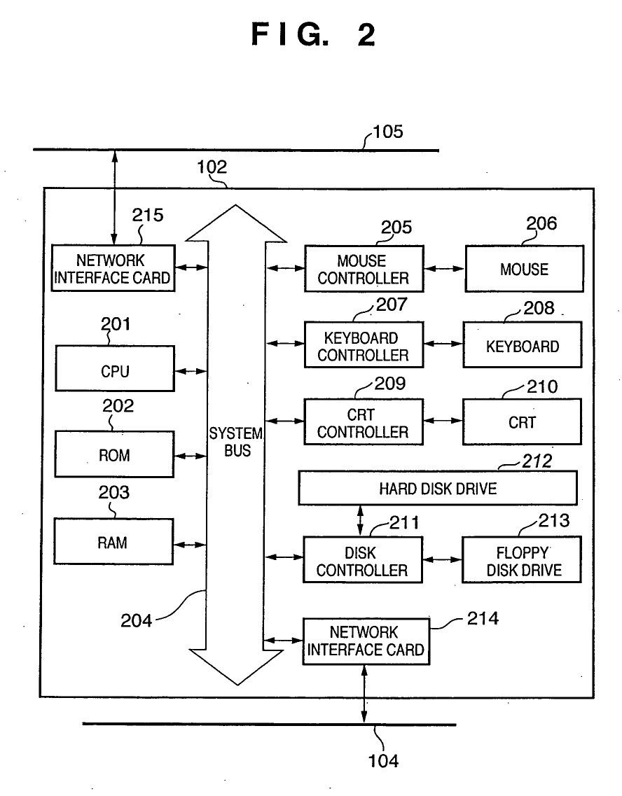

The internal configuration of the external control device 102 will be described with reference to FIG. 2. As shown in FIG. 2, the external control device 102 comprises a CPU 201, ROM 202, and RAM 203. The external control device 102 also comprises a mouse controller 205, mouse 206, keyboard controller 207, keyboard 208, CRT controller 209, CRT 210, and disk controller 211. The external control device 102 further comprises a hard disk drive 212, floppy® disk drive 213, and network interface cards 214 and 215.

The CPU 201 controls the operation of the whole external control device 102. The ROM 202 stores various programs, data, and the like for controlling the operation of the CPU 201. The RAM 203 includes a main memory, work area, and the like for the CPU 201. The mouse controller 205 controls an instruction input from the mouse 206. The keyboard controller 207 controls an instruction input from the keyboard 208 or pointing device (not shown). The CRT controller 209 controls display of the CRT display 210. The hard disk drive 212 and floppy® disk drive 213 store various programs and data (boot program, operating system, various applications, and the like). The disk controller 211 controls access to the hard disk drive 212 and floppy® disk drive 213.

The network interface cards 214 and 215 are respectively connected to the local network 105 and network 104 in the user environment. The network interface card 214 exchanges data with the FTP server 103 and PC via the network 104 in two directions. The network interface card 215 exchanges data with the image processing apparatus 101 via the local network 105 in two directions. The above building components can communicate with each other via a system bus 204.

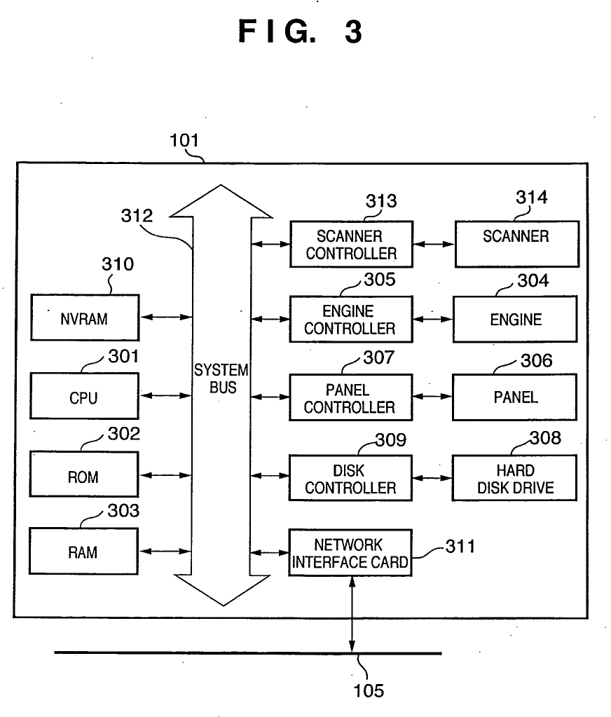

The configuration of the image processing apparatus 101 which receives a print job will be described with reference to FIG. 3. As shown in FIG. 3, the image processing apparatus 101 comprises a CPU 301, ROM 302, and RAM 303. The image processing apparatus 101 also comprises an engine 304, engine controller 305, panel 306, and panel controller 307. The image processing apparatus 101 further comprises a hard disk drive 308, disk controller 309, NVRAM 310, network interface card 311, scanner controller 313, and scanner 314.

The CPU 301 controls the operation of the overall image processing apparatus 101. The ROM 302 stores various programs, data, and the like for controlling the operation of the CPU 301. The RAM 303 includes a main memory, work area, and the like for the CPU 301. The engine 304 implements device functions (printer function, copy function, and the like). The engine controller 305 controls driving of the engine 304. The panel 306 accepts various operation instructions from the user, and displays various types of information. The panel controller 307 controls an input/output to/from the panel 306, and manages the panel 306. The hard disk drive 308 stores various programs and data, and the disk controller 309 controls access to the hard disk drive 308. The NVRAM 310 is a nonvolatile RAM. The network interface card 311 exchanges data with the external control device 102 and FTP server 103 via the local network-105 in two directions. The scanner controller 313 controls the scanner 314. The above building components can communicate with each other via a system bus 312.

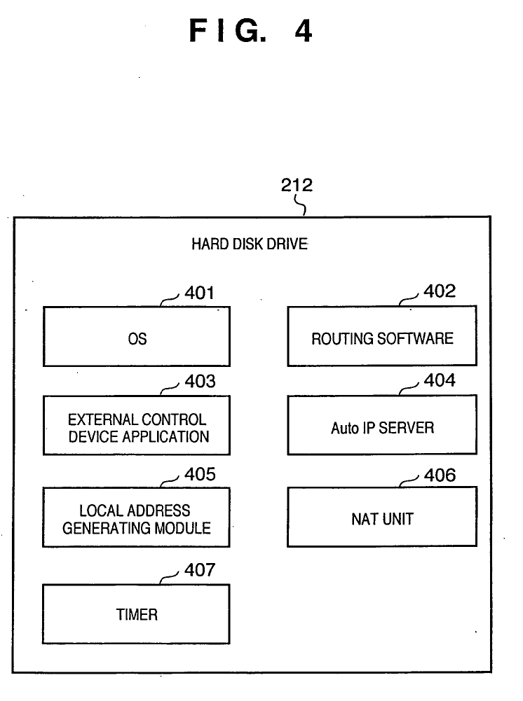

Typical examples of software programs stored in the hard disk drive 212 of the external control device 102 will be explained with reference to FIG. 4. As shown in FIG. 4, the hard disk drive 212 saves a plurality of software programs for controlling respective functions, and can read them out on request. In FIG. 4, an OS 401 is an operating system. Routing software 402 routes data exchanged between the network interface cards 214 and 215 to the partner network interface cards.

A local address generating module 405 is software for generating IP addresses to be assigned to the image processing apparatus 101 and the network interface card 215 of the external control device 102. A CPU which implements this module functions as an IP address generating means for generating an IP address. The local address generating module 405 also functions as an IP address recognizing means for inquiring, of the OS 401, information on an IP address and subnet mask corresponding to the network interface card 214 of the external control device 102. Moreover, the local address generating module 405 functions as a confirming means for confirming an IP address used in a network directly or indirectly connected to the external control device 102.

An NAT unit 406 is a subset module of the routing software 402, and is software for connecting the local network 105 and network 104 by NAT (Network Address Translation). A timer 407 manages these software programs by time. The NAT unit 406 functions as an address translating means for translating the address of a network packet when a node on the local network communicates with a node on another local network.

An external control device application 403 is software having various functions to complement the functions of the image processing apparatus 101. An example of the functions of the external control device application 403 is an encrypted-communication function. In the first embodiment, the image processing apparatus 101 does not have any encrypted-communication function. In this case, the external control device application 403 receives encrypted print data from a printing client, decrypts the data, and transmits the decrypted data to the image processing apparatus 101. This can ensure security of data flowing through the public network 104.

An Auto IP server 404 is a module which supplies an IP address to the image processing apparatus 101 by using the DHCP protocol, and functions as an automatic IP address setting means for dynamically assigning an IP address to a node on the local network. For this purpose, the Auto IP server 404 listens to the port of the network interface card 215.

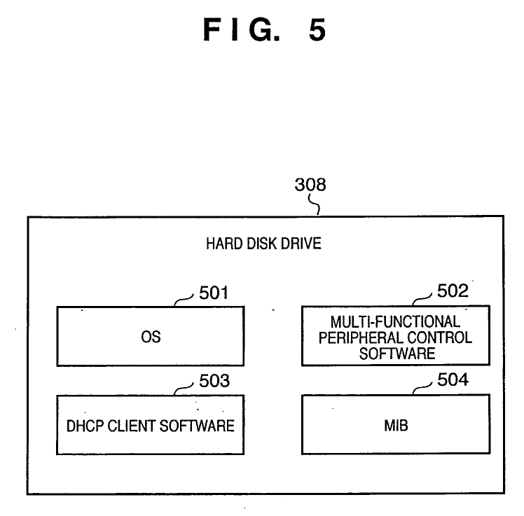

Typical examples of software programs stored in the hard disk drive 308 of the image processing apparatus 101 will be explained with reference to FIG. 5. As shown in FIG. 5, the hard disk drive 308 saves a plurality of software programs for controlling respective functions, and can read them out on request. In FIG. 5, an OS 501 is an operating system. Multi-functional peripheral control software 502 controls the operation of the whole multi-functional peripheral. The multi-functional peripheral control software 502 contains a module for performing SNMP (Simple Network Management Protocol) protocol communication. DHCP client software 503 sends a DHCP request, and externally acquires information on an IP address, subnet mask, and default gateway.

An MIB (Management Information Base) 504 is a device information database.

A configuration to implement packet routing of the external control device 102 will be explained in more detail. The external control device 102 is equipped with NAT as a routing function. NAT establishes one-to-one correspondence between an IP address in a local network and that in a public network. When a network node having the IP address of the local network is to communicate with a node in the public network, the IP address of the local network is rewritten into that of the public network.

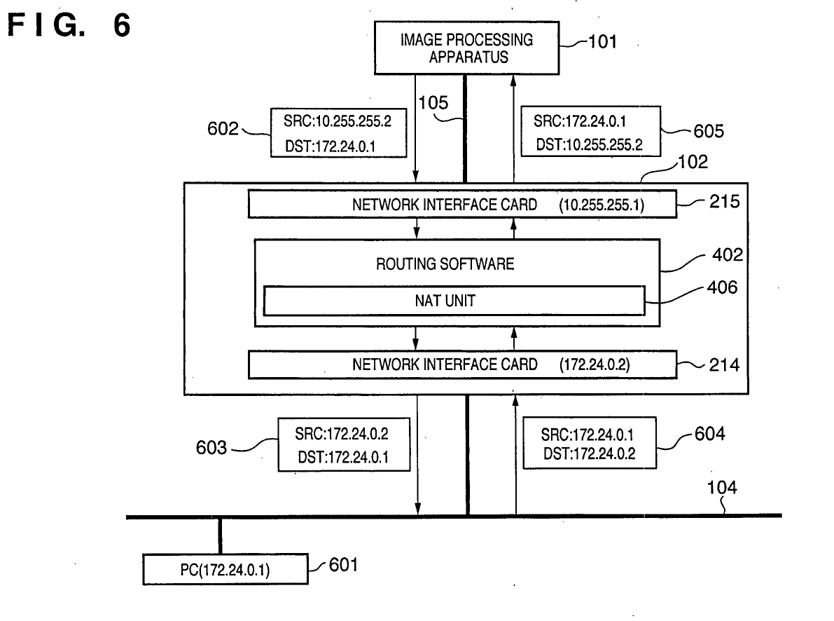

NAT will be concretely described with reference to FIG. 6. FIG. 6 shows a change in IP address in a packet when the image processing apparatus 101 communicates with a PC 601 by the IP protocol. Assume that the IP address of the image processing apparatus 101 is 10.255.255.2, and an IP address of the external control device on the side of the local network 105 is 10.255.255.1. Also assume that an IP address of the external control device 102 on the side of the network 104 is 172.24.0.2, and that of the PC 601 is 172.24.0.1. The local network 105 and network 104 have different network addresses, so the external control device. 102 must function as a router when the image processing apparatus 101 IP-communicates with the PC 601.

A default gateway address set in the image processing apparatus 101 is 10.255.255.2 which is an IP address of the external control device. In this state, the image processing apparatus 101 tries to communicate with the PC 601 by TCP/IP. The source IP address of an IP protocol field contained in a packet 602 transmitted from the image processing apparatus 101 to the PC 601 is 10.255.255.2, and the destination IP address is 172.24.0.1. The packet 602 reaches the external control device 102 serving as a router.

The IP address of the packet 602 received by the network interface card 215 is rewritten by the NAT unit 406 serving as a subset module of the routing software 402. The NAT unit 406 rewrites the source IP address of the packet 602 from the IP address of the image processing apparatus 101 into an IP address of the external control device 102 on the public network side, and transmits the packet to the destination IP address. The source IP address of a packet 603 transmitted from the external control device 102 to the network 104 is 172.24.0.2 which is an IP address of the external control device on the public network side. The destination IP address of the packet 603 is 172.24.0.1 which is the IP address of the PC 601. That is, the source IP address of a packet transmitted from the image processing apparatus 101 into the public network 104 is rewritten through the external control device 102 so that it looks as if the external control device 102 sent the packet.

The PC 601 receives the packet 603, and replies to the packet. A reply packet 604 sent from the PC 601 is addressed to the image processing apparatus 101. However, the source IP address of the packet 603 received by the PC 601 is the address of the external control device 102, so the PC 601 sends the packet to the external control device 102. The destination IP address of the packet 604 is 172.24.0.2 which is an IP address of the external control device on the public network side, and the source IP address is 172.24.0.1 which is the IP address of the PC 601. Upon reception of the packet 604, the external control device 102 rewrites the destination IP address into the address of the image processing apparatus 101, and sends the packet to the local network 105.

The destination IP address of a sent packet 605 is 10.255.255.2 which is the address of the image processing apparatus 101, and the source IP address is 172.24.0.1 which is the address of the PC 601. As a result, the packet 605 is received by the image processing apparatus 101.

In this way, according to NAT, the external control device 102 serving as a router rewrites an IP address, thereby allowing the image processing apparatus 101 to communicate with a node on the network 104 without externally leaking the local IP address of the image processing apparatus 101. In this case, whether NAT can be executed is not determined by the value of a destination port when the image processing apparatus 101 communicates with a node on the network 104 by TCP or UDP. The NAT unit 406 performs NAT processing and permits communication regardless of the listening port number of a node serving as a communication destination of the image processing apparatus 101. To the contrary, communication of a node on the network 104 to the external control device 102 or image processing apparatus 101 is restricted for security.

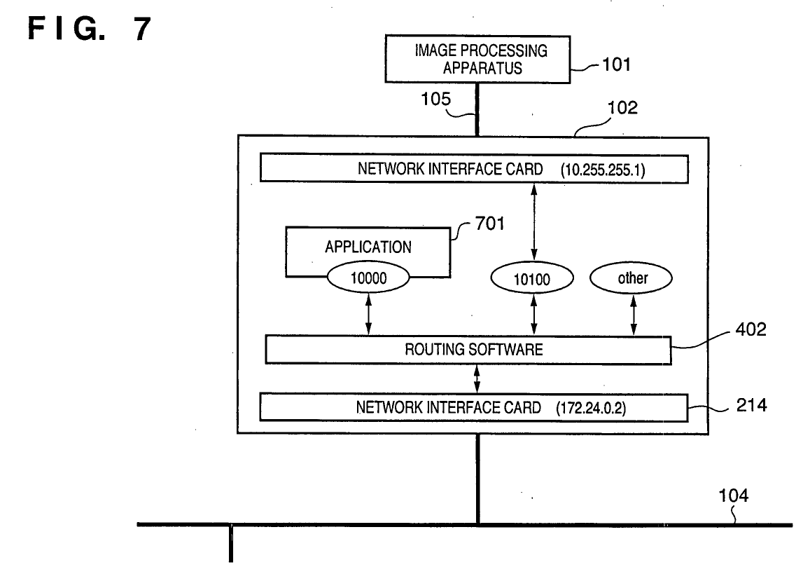

FIG. 7 is a view for explaining an operation when the external control device 102 receives communication from a node on the network 104 by TCP/IP or UDP/IP. An application 701 having a function of communicating with a node on the network 104 by TCP/IP runs in the external control device 102. The application 701 always opens TCP port No. 10000 on the side of the network interface 214 and listens to the port. The routing software 402 has a setting of transferring a packet at TCP port No. 10100 on the side of the network interface 214 to the image processing apparatus 101.

The routing software 402 rewrites the destination IP address of an IP packet received at the TCP port No. 10100 on the side of the network interface 214 to 10.255.255.2 which is the address of the image processing apparatus 101. Then, the routing software 402 transmits the IP packet to the local network 105. More specifically, if the destination port of an IP packet received by the external control device 102 through the network interface 214 is 10000, the routing software 402 transfers the IP packet to the application 701, and if the destination port is 10100, transfers the IP packet to the image processing apparatus 101. When the destination port represents another port number, the packet is discarded. That is, when a node on the network 104 is to IP-communicate with the image processing apparatus 101, a destination port number for use must be registered in advance in the routing software 402.

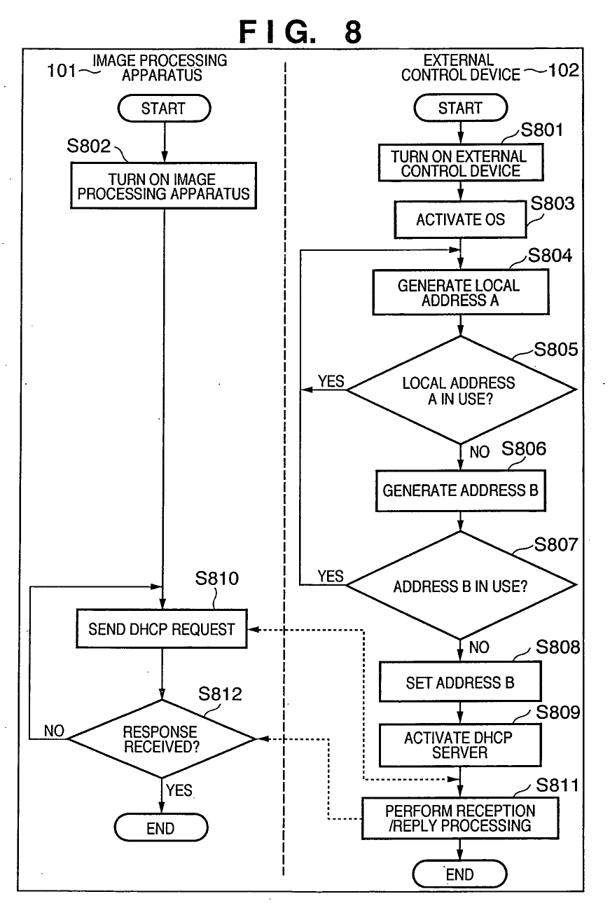

The flow of the operation according to the first embodiment will be explained with reference to FIG. 8. In step S801, the user turns on the external control device 102. In the first embodiment, the user must synchronize the power supplies of the power supplies of the external control device 102 and image processing apparatus 101 in order to maintain collaboration of their respective functions. The image processing apparatus 101 and external control device 102 cannot effectively exploit all functions singly. To use the external control device 102 and image processing apparatus 101 singly or in combination, the user must turn on both of them. In step S802, therefore, the user turns on the image processing apparatus 101.

In step S803, the OS of the external control device 102 starts. At this time, the OS 401 stored in the hard disk drive 212 is loaded into the RAM 203. After the basic operation of the OS starts, the local address generating module 405 temporarily determines local address A as an IP address of the external control device 102 on the side of the local network 105 in step S804. The local address generating module 405 inquires, of the OS 401, information on an IP address and subnet mask corresponding to the network interface card 214 of the external control device 102. In the first embodiment, static address values are set as the IP address and subnet mask corresponding to the network interface card 214, and address X is 172.24.0.1/24.

The local address generating module 405 generates an IP address which belongs to a space different from the network space of address X and is a private IP address. The subnet mask corresponding to the network interface card 214 is 255.255.255.0. Hence, the network space to which the IP address corresponding to the network interface card 214 belongs is 172.24.0.255. The local address generating module 405 generates an IP address from values which belong to a network different from the network “172.24.0.255” and end with odd numbers. The local address generating module 405 generates an IP address of 192.168.99.1 (local address A).

In step S805, the local address generating module 405 checks whether local address A is already in use at a node on the network 110, due to the following reason. That is, when a node on the network 110 is using local address A, a conflict may occur in the routing table of the external control device 102, obstructing communication of the external control device.

The network 110 is connected via the router 107, unlike a network directly connected to the external control device 102. Even in this case, when a node on the network 110 is using local address A, the following addresses are recorded upon communication between the node and the external control device 102 by the IP protocol:
the IP address of the node
the address of a network interface used
the address of the router 107
   Note that the address is recorded in the routing table of the external control device 102. When local address A is used in the network interface card 215 of the external control device 102 or the image processing apparatus 101, information on the IP address of the external control device 102 or image processing apparatus 101 and the network interface to be used is also recorded in the routing table. Although the network interfaces of the node and image processing apparatus 101 are the network interface cards 214 and 215, their destination IP addresses are identical. For this reason, the external control device 102 cannot determine to which of the network interfaces a packet is to be sent.

The local address generating module 405 sends ARP to a network on the side of the network interface card 214 to check whether the node is using address A. Note that ARP is an abbreviation for Address Resolution Protocol. In the first embodiment, a default gateway set in the OS 401 is the IP address of the router 107. The local address generating module 405 sends ARP to the network on the side of the network interface card 214. At this time, the IP address of the destination station in the ARP protocol is 192.168.99.1.

A destination MAC address contained in the data link layer is an MAC address of the router 107 on the side of the network 104. A destination MAC address contained in the ARP protocol is all “0”s. The ARP packet sent from the local address generating module 405 is received by the router 107. Since the MAC address contained in the data link layer of the received ARP packet coincides with the address of the router 107, the router 107 recognizes that the ARP is addressed to itself.

Since a destination IP address contained in the ARP protocol is 192.168.99.1 which is different from the address of the router 107, the router 107 transfers the received ARP packet. By referring to the routing table of the router 107, the router 107 maps a network to which the IP address “192.168.99.1” belongs. Assuming that an address space corresponding to the IP address “192.168.99.1” is being used by the network 110, the router 107 sends ARP to the network 110. At this time, a destination MAC address contained in the data link layer is a broadcast address. The IP address of the destination station that is contained in the ARP protocol is 192.168.99.1. The IP address of the source station is an IP address of the router 107 on the side of the network 110.

If a node having the IP address “192.168.99.1” exists in the network 110, the node sends back an ARP response. Although the node transmits the ARP response, MAC address information contained in the data link layer is the MAC address of the node. The IP address of the destination station that is contained in the ARP protocol is an IP address of the router 107 on the side of the network 110, and the IP address of the source station is the IP address “192.168.99.1” of the node. The router 107 receives the ARP response, and transmits it to the external control device 102. A source MAC address contained in the data link layer of the ARP response sent from the router 107 to the external control device 102 is an MAC address of the router 107 on the side of the network 104. The IP address of the destination station that is contained in the ARP protocol is the IP address “172.24.0.1” of the external control device 102 on the side of the network interface card 214. The IP address of the source station is the IP address of a node on the network 110.

In the first embodiment, no node having the address “192.168.99.1” exists in the network 110, and no ARP response is sent back. If an ARP response is received in step S805, it can be determined that the address “192.168.99.1” cannot be used as the IP address of the network interface 215. In order to perform temporary address generation processing again, step S804 is executed. When an IP address is generated again in step S804, the generated IP address is not used until the external control device 102 is turned off.

In this manner, when a generated IP address has already been used, IP address generation processing is repeated again. A free IP address can be reliably set to ensure communication between networks.

In step S804, the local address generating module 405 temporarily determines local address A of the external control device 102 on the side of the local network 105. If it is determined in step S805 that local address A has not been used, the local address generating module 405 temporarily determines IP address B as an IP address to be distributed to the image processing apparatus 101 in step S806. IP address B is set to a value of local address A+1. Since local address A is an odd number and IP address B is set to a value of local address A+1, communication can be done between local address A and IP address B through a virtually minimum net mask of 255.255.255.252.

In this case, local address A is 192.168.99.1, and thus IP address B is 192.168.99.2. After IP address B to be distributed to the image processing apparatus 101 is temporarily determined by this method, the local address generating module 405 determines in step S807 whether IP address B is already in use at a node on the network 110. More specifically, almost the same processing as that described in step S805 is performed. That is, the local address generating module 405 sends ARP to the network on the side of the network interface card 214, and checks whether a node uses address B.

Note that the IP address of the destination station in the ARP protocol when the local address generating module 405 sends ARP to the network on the side of the network interface card 214 is 192.168.99.2 (=the value of IP address B).

In the first embodiment, assume that no node on the network 110 sends back any reply. From this, it can be determined that IP address B is not being used by any node on the network 110. Local address A and IP address B can be used as the IP addresses of the network interface card 215 and image processing apparatus 101, respectively, and their address values are determined. If an ARP response is received, it can be determined that the address “192.168.99.2” cannot be used as the IP address of the image processing apparatus 101. In this case, the flow returns to step S804, and the local address generating module 405 generates the temporary addresses of the network interface card 215 and image processing apparatus 101 again.

After the IP addresses of the network interface card 215 and image processing apparatus 101 are determined by a series of processes from step S804 to step S807, the flow advances to step S808. In step S808, the OS 401 of the external control device 102 sets the IP address of the network interface 215 of the external control device 102. The IP address of the network interface 215 of the external control device 102 is local address A (192.168.99.1) determined in steps S804 and S805. The local address generating module notifies the OS 401 of local address A. The OS 401 sets the value of the notified local address A as the IP address of the network interface 215. By this processing, the IP address associated with the network interface 215 changes to local address A (192.168.99.1).

The IP address associated with the network interface 214 of the external control device 102 is 172.24.0.1, and that associated with the network interface 215 is 192.168.99.1. Consequently, no conflict occurs in the routing table of the OS 401 that is referred to by the NAT unit 406 in NAT processing. The NAT unit 406 can, therefore, execute NAT processing.

In step S809, the external control device 102 activates the DHCP server. That is, the IP address distribution function of the Auto IP server 404 is activated. At this time, the Auto IP server 404 itself is already active in the external control device 102, but the IP address distribution function in the Auto IP server 404 is invalid. IP address distribution becomes valid upon reception of an IP address from the local address generating module 405.

In step S809, the local address generating module 405 uses the value “192.168.99.1” generated as the IP address of the external control device 102 for communication between applications using a local loopback address. The local address generating module 405 notifies the Auto IP server 404 of the IP address. Upon reception of the notification, the Auto IP server 404 starts IP address distribution processing. IP address distribution is implemented by the DHCP protocol. The Auto IP server 404 functions as a DHCP server, and distributes an IP address to a node on the local network 105. The Auto IP server 404 operates as a DHCP server for only the network interface card 215, and does not perform port listening of the network interface card 214.

After the external control device 102 can distribute an IP address, the DHCP client software 503 which runs in the image processing apparatus 101 sends a DHCP request in step S810. In step S811, the external control device 102 sends back information on an IP address, subnet mask, and default gateway in response to the received DHCP request.

Immediately after the image processing apparatus 101 is turned on and activated, it does not have any valid IP address corresponding to the network interface card 311. For this reason, the DHCP client software 503 acquires an IP address from the external control device 102 by the DHCP protocol. An IP address supplied from the Auto IP server 404 of the external control device 102 is 192.168.99.2, the subnet mask is 255.255.255.252, and the default gateway is 192.168.99.1. The subnet mask takes a minimum mask value which can be set when the external control device 102 and image processing apparatus 101 belong to the same network in the local network 105. The default gateway is the IP address of the network interface card 215 of the external control device 102, and is information necessary for the image processing apparatus 101 to communicate with a node by NAT.

The external control device 102 and image processing apparatus 101 are not synchronized in their activation orders. Thus, in step S809, the image processing apparatus 101 may be activated before the *Auto IP server 404 becomes a DHCP communicable state. Further, in step S810, the DHCP client software 503 may send a request by the DHCP protocol. To prevent this, after a request is sent by the DHCP protocol in step S810, the flow advances to step S812 to determine whether the Auto IP server 404 sends back a response. If the Auto IP server 404 does not send back any response, the flow returns to step S810 to send a DHCP request at a predetermined interval. If the DHCP client software 503 can obtain a response to the sent DHCP request in step S812, address acquisition processing by DHCP ends.

The image processing apparatus 101 acquires an IP address, subnet mask, and default gateway from the external control device 102, and sets these values as IP information corresponding to the network interface card 311. Thereafter, network communication becomes valid.

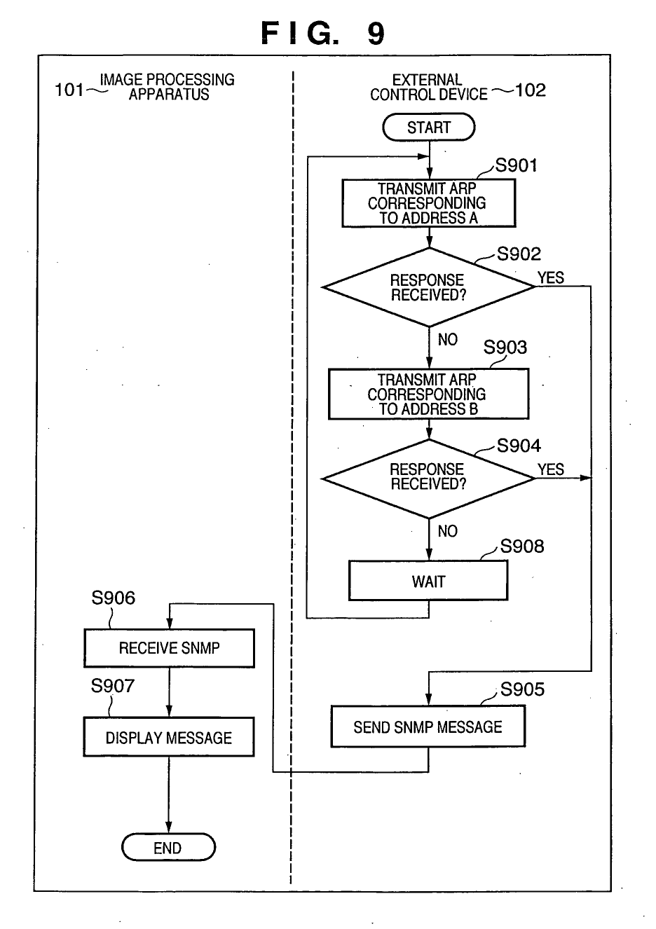

Along this flow, the external control device 102 and image processing apparatus 101 are activated, and the external control device determines whether its network is valid. If the network is valid, the external control device 102 checks whether nodes using IP addresses corresponding to the network interface card 215 and the network interface card 311 of the image processing apparatus 101 do not exist in the network. The flow of this processing will be explained with reference to FIG. 9.

In FIG. 9, the image processing apparatus 101 and external control device 102 are active in an initial state. The network interface card 214 of the external control device 102 has an IP address of 172.24.0.1. The network interface card 215 is set to 192.168.99.1, and the network interface card 311 of the image processing apparatus 101 is set to 192.168.99.2. In step S901, the local address generating module 405 sends ARP to a network on the side of the network interface card 214. In step S902, the local address generating module 405 determines whether it receives an ARP response, and thereby checks whether the node is using the address “192.168.99.1”.

The default gateway set for the OS 401 is the IP address of the router 107. The local address generating module 405 sends ARP to a network on the side of the network interface card 214, and the IP address of the destination station in the ARP protocol is 192.168.99.1. A destination MAC address contained in the data link layer is an MAC address of the router 107 on the side of the network 104. A destination MAC address contained in the ARP protocol is all “0”s.

The ARP packet sent from the local address generating module 405 is received by the router 107. Since the MAC address contained in the data link layer of the received ARP packet coincides with the address of the router 107, the router 107 recognizes that the ARP packet is addressed to itself. Since a destination IP address contained in the ARP protocol is 192.168.99.1 which is different from the address of the router 107, the router 107 transfers the received ARP packet. By referring to the routing table of the router 107, the router 107 maps a network to which the IP address “192.168.99.1” belongs.

Assuming that the address space is being used by the network 110, the router 107 sends ARP to the network 110. At this time, a destination MAC address contained in the data link layer is a broadcast address. The IP address of the destination station that is contained in the ARP protocol is 192.168.99.1. The IP address of the source station is an IP address of the router 107 on the side of the network 110. If a node having the IP address “192.168.99.1” exists in the network 110, the node sends back an ARP response to the router 107.

Note that MAC address information contained in the data link layer in transmitting an ARP response from the node is the MAC address of the node itself. The IP address of the destination station that is contained in the ARP protocol is an IP address of the router 107 on the side of the network 110, and the IP address of the source station is the IP address “192.168.99.1” of the node. The router 107 receives the ARP response, and transmits it to the external control device 102. A source MAC address contained in the data link layer of the ARP response sent from the router 107 to the external control device 102 is an MAC address of the router 107 on the side of the network 104. The IP address of the destination station that is contained in the ARP protocol is the IP address “172.24.0.1” of the external control device 102 on the side of the network interface card 214. The IP address of the source station is the IP address of the node on the network 110.

If the external control device 102 receives the ARP response from the router 107, it can determine that the address “192.168.99.1” cannot be used as the IP address of the network interface 215. The flow advances from step S902 to step S905, and the external control device 102 prompts the user to perform reactivation.

If the external control device 102 does not receive any ARP response from the router 107, it can determine that no node using the address “192.168.99.1” exists in the range where the external control device 102 can perform IP communication on the side of the network interface card 214. Thus, the flow shifts to processing in step S903.

In step S903, the local address generating module 405 checks the use state of the IP address “192.168.99.2” of the image processing apparatus 101. By the same method as that in step S901, the local address generating module 405 tests whether a node using the address “192.168.99.2” exists in the range where the external control device 102 can perform IP communication on the side of the network interface card 214. If the external control device 102 receives an ARP response, it can determine that the address “192.168.99.2” cannot be used as the IP address of the network interface card 311. Thus, the external control device 102 prompts the user to perform reactivation. If the external control device 102 does not receive any ARP response, it can determine that no node using the address “192.168.99.2” exists in the range where the external control device 102 can perform IP communication on the side of the network interface card 214. The flow shifts to processing in step S908.

In step S908, the external control device 102 activates the timer 407 and waits for a predetermined time. Upon the lapse of the predetermined time, the flow returns to step S901, and the external control device 102 checks the use state of the IP address again.

If the external control device 102 receives an ARP response in step S902 or S904, a conflict occurs in the routing table held by the OS 401 in the external control device 102, and communication with nodes having these IP addresses may fail. To prevent this, the image processing apparatus 101 displays, on its panel 306, a message which prompts the user to reactivate the external control device 102 and image processing apparatus 101.

By displaying a message, the user can avoid a failure in communication between local networks.

In step S905, the local address generating module 405 notifies the image processing apparatus 101 of a message by using SetRequest of the SNMP protocol. An OID used represents the range of a private MIB, and includes an object for displaying a message on the panel. The local address generating module 405 sets a predetermined OID in the SNMP format of SetRequest. The local address generating module 405 sets, as a value, an ID representing a message of contents which prompt reactivation of the external control device 102 and image processing apparatus 101. Then, the external control device 102 transmits an SNMP packet to the image processing apparatus 101.

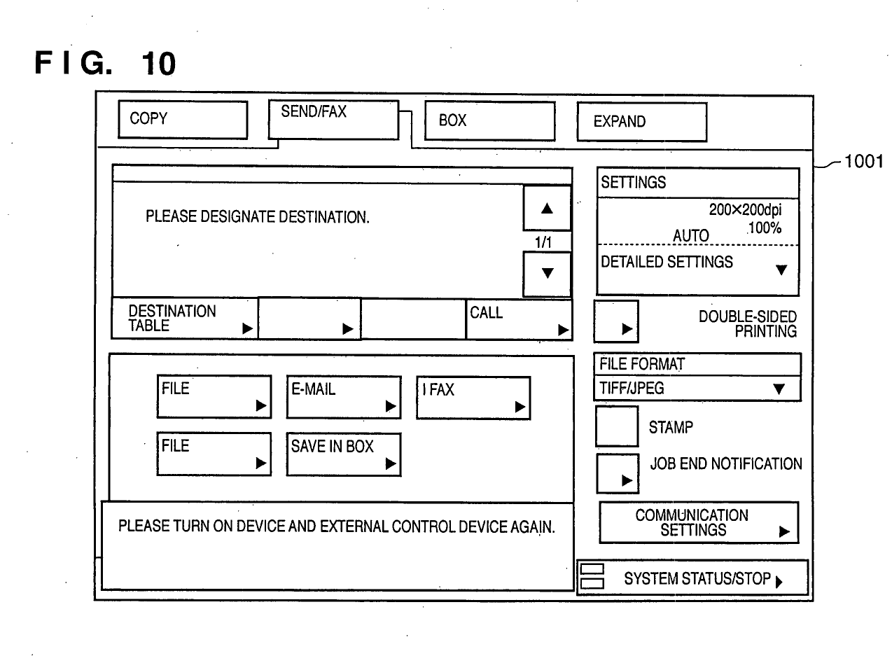

In step S906, the image processing apparatus 101 receives the SNMP packet. The SNMP message is analyzed by the multi-functional peripheral control software 502, and the received object value is set in the MIB 504. In step S907, the multi-functional peripheral control software 502 displays a message as shown in FIG. 10 on the panel 306 in accordance with an instruction set in the MIB 504.

In FIG. 10, a message is displayed at a lower portion of the menu window of the multi-functional peripheral that is displayed on the panel 306. A message 1001 “please turn on the device and external control device again.” is displayed at a lower portion of the panel to prompt the user to turn on the image processing apparatus 101 and external control device 102 again. By this processing, the OSs of the image processing apparatus 101 and external control device 102 are activated again, and IP addresses used in the local network 105 are reassigned.

As described above, according to the first embodiment, the external control device which performs routing is interposed between a local network and a public network. The external control device operates as follows in an environment where an IP packet is transferred by NAT.

More specifically, IP addresses are generated and set so that an IP address and IP network used in the local network and those used in the public network do not overlap each other. The information processing apparatus connected to the local network can communicate with the external control device or a node on the public network without any problem. To the contrary, even a node on the public network can communicate with the external control device or a device connected to the local network without any problem.

The external control device searches for IP network information used in the public network every communication, and automatically generates and assigns an IP address and related information. The user need not manually input any address, and can easily manage the network.

### Second Embodiment

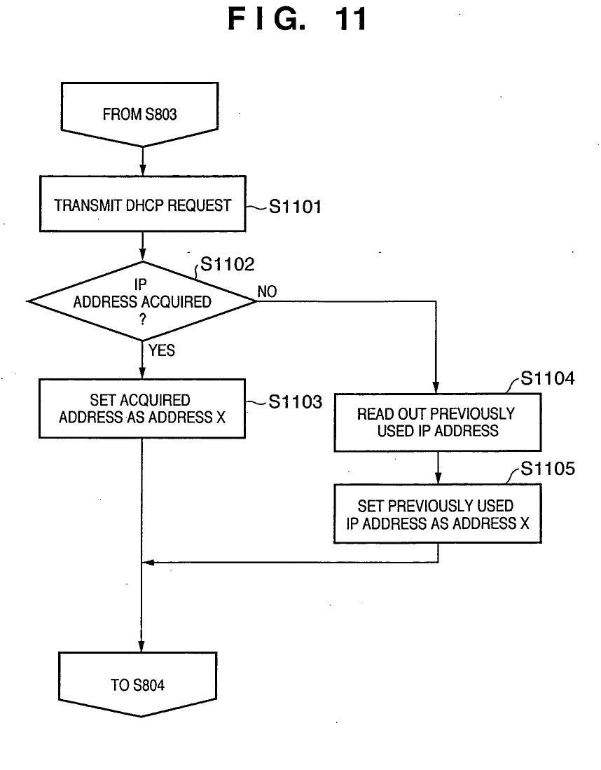

The second embodiment of the present invention will be explained with reference to the accompanying drawings. The second embodiment is different from the first embodiment mainly in that an IP address corresponding to a network interface 214 on the side of a network 104 is dynamically determined. In the second embodiment, the configurations of respective devices are the same as those described in the first embodiment. The operation flows of an image processing apparatus 101 and external control device 102 include some processes which are identical to those in the flow shown in FIG. 8 according to the first embodiment. In the second embodiment, processes using a different method will be explained with reference to FIG. 11 along the basic flow of FIG. 8. A series of processes from step S801 to step S803 in FIG. 8 is identical to that described in the first embodiment.

In the second embodiment, the flow shifts to step S1101 shown in FIG. 11 after the end of processing in step S803. In step S1101, the external control device 102 adopts a means for dynamically acquiring a value as an IP address corresponding to the network interface 214, which is different from the first embodiment. An OS 401 sends an IP address acquisition request to the network 104 by the DHCP protocol, and the flow advances to step S1102. In step S1102, the OS 401 determines whether the IP address has been acquired. If a DHCP server 108 on the network 104 sends back a response to the sent request, this means that the external control device 102 has correctly acquired IP address information. The network interface card 214 is made to correspond to the IP address.

After the IP address information is acquired, the OS 401 generates the value of address X serving as a variable representing the IP address of the network interface card 214 in step S1103. In step S1103, processing when private address information can be acquired from the DHCP server 108 is executed. The OS 401 sets the acquired IP address as the IP address of the network interface card 214. Further, the OS 401 sets the acquired IP address value as address X serving as an internal variable representing the IP address of the network interface card 214.

After that, the flow shifts to processing in step S804 of FIG. 8. With this processing, local address A generated in step S804 is calculated not to overlap address X of the network. In a description of step S804 according to the first embodiment, address X is a static IP address “172.24.0.1/24”. In the second embodiment, however, an IP address is acquired by the DHCP protocol, and if the value of the IP address is set as address X, this value is preferentially used.

If no IP address information is acquired, for example, no response is received from the DHCP server 108, the flow shifts to processing in step S1104. In step S1104, processing when acquisition of an IP address by the DHCP protocol fails in step S1102 is executed. The OS 401 reads out the latest IP address value among IP addresses which were valid as IP addresses corresponding to the network interface card 214.

The OS 401 loads a file which exists as part of the configuration file of the OS 401 and records the latest IP address used as an IP address of the network interface card 214 by the external controller 102. The OS 401 and a local address generating module 405 set the IP address read out in step 51104 as address X (step S1105). Then, the flow shifts to processing in step S804 of FIG. 8. That is, local address A generated in step S804 is calculated not to overlap address X of the network.

### Other Embodiment

The embodiments of the present invention have been described in detail. The present invention can be applied to a system made up of a plurality of devices, or an apparatus formed from a single device.

The present invention is also achieved even by supplying a program which implements the functions of the above-described embodiments to the system or apparatus directly or from a remote site and causing the system or apparatus to read out and execute the supplied program code. Hence, to implement the functional processing of the present invention by a computer, the program code itself, which is installed in the computer, is also incorporated in the present invention.

In this case, the program can take any form such as an object code, a program to be executed by an interpreter, or script data to be supplied to the OS as long as the functions of the program can be obtained.

As a recording medium to supply the program, for example, a floppy® disk, hard disk, optical disk, magnetooptical disk, MO, CD-ROM, CD-R, CD-RW, magnetic tape, nonvolatile memory card, ROM, or DVD (DVD-ROM or DVD-R) can be used.

The program supply method is not limited to this. For example, a client computer may be connected to a homepage on the Internet using a browser in the computer, and the computer program itself of the present invention may be downloaded to a recording medium such as a hard disk. At this time, the data to be downloaded may be the computer program itself of the present invention or a compressed file containing an automatic install function.

A program code that forms the program of the present invention may be divided into a plurality of files, and the files may be downloaded from different homepages. That is, a WWW server which permits a plurality of users to download a program file that causes a computer to implement the functional processing of the present invention is also incorporated in the claim of the present invention.

The program of the present invention may be encrypted, stored in a storage medium such as a CD-ROM, and distributed to users. Any user who satisfies predetermined conditions may be allowed to download key information for decryption from a homepage through the Internet. In this case, the key information is used to execute the encrypted program and install the program in the computer.

The functions of the above-described embodiments may be implemented by executing the readout program by the computer. Further, the functions of the above-described embodiments may also be implemented by performing part or all of actual processing by the OS or the like, which is running on the computer, on the basis of the instructions of the program.

These functions may also be implemented when the program read out from the recording medium is written in the memory of a function expansion board inserted into the computer or a function expansion unit connected to the computer, and processing is performed on the basis of the instructions of the program. In this case, the processing may be done by, e.g., the CPU of the function expansion board or function expansion unit.

The present invention is not limited to the above embodiments and various changes and modifications can be made within the spirit and scope of the present invention. Therefore to apprise the public of the scope of the present invention, the following claims are made.

This application claims the benefit of Japanese Application No.2005-063153 filed on Mar. 7, 2005, which is hereby incorporated by reference herein in its entirety.

What is claimed is:

1. An information processing apparatus interposed between a first network and a second network, comprising:
address generating unit configured to generate a first address for the first network and a second address for the first network which are not in use in the second network;
first address setting unit configured to set the first address as an address of the information processing apparatus for the first network; and
second address setting unit configured to assign the second address to a node on the first network.

2. An information processing apparatus interposed between a first network and a second network, comprising:
address converting unit configured to convert an address of a network packet when a node on the first network is to communicate with a node on the second network;
address recognizing unit configured to recognize an address and subnet mask of the information processing apparatus for the second network;
address generating unit configured to generate, on the basis of the address and the subnet mask recognized by said address recognizing unit, a first address for the first network and a second address for the first network which are not in use in the second network;
determining unit configured to determine whether the first address and the second address are in use in the second network and a third network connected to the second network via a router;
first address setting unit configured to set the first address as an address of the information processing apparatus for the first network when said determining unit determines that the first address is not in use; and
second address setting unit configured to assign the second address to a node on the first network when said determining unit determines that the second address is not in use.

3. The apparatus according to claim 2, wherein when said determining unit determines that the first address and the second address are in use, said address generating unit generates another first address and another second address again.

4. The apparatus according to claim 2, further comprising message notifying unit configured to output a warning message when said determining unit determines that the first address and the second address are in use.

5. The apparatus according to claims 2, wherein said determining unit uses Address Resolution Protocol to confirm an address use state in the third network.

6. An information processing method executed in an information processing apparatus interposed between a first network and a second network, comprising:
an address generating step of generating a first address for the first network and a second address for the first network which are not in use in the second network;
a first address setting step of setting the first address as an address of the information processing apparatus for the first network; and
a second address setting step of assigning the second address to a node on the first network.

7. An information processing method executed in an information processing apparatus interposed between a first network and a second network, comprising:
an address recognizing step of recognizing an address and subnet mask of the information processing apparatus for the second network;
an address generating step of generating, on the basis of the address and the subnet mask recognized in the address recognizing step, a first address for the first network and a second address for the first network which are not in use in the second network;
an address determining step of determining whether the first address and the second address are in use in the second network and a third network connected to the second network via a router;
a first address setting step of setting the first address as an address of the information processing apparatus for the first network when the first address is determined in the address determining step not to be in use;
a second address setting step of assigning the second address to a node on the first network when the second address is determined in the address determining step not to be in use; and
an address converting step of converting an address of a network packet when a node on the first network is to communicate with a node on the second network by using the first address and the second address.

8. An information processing program for controlling an information processing apparatus interposed between a first network and a second network, causing the information processing apparatus to execute
an address generating step of generating a first address for the first network and a second address for the first network which are not in use in the second network,
a first address setting step of setting the first address as an address of the information processing apparatus for the first network, and
a second address setting step of assigning the second address to a node on the first network.

9. An information processing program for controlling an information processing apparatus interposed between a first network and a second network, causing the information processing apparatus to execute
an address recognizing step of recognizing an address and subnet mask of the information processing apparatus for the second network,
an address generating step of generating, on the basis of the address and the subnet mask recognized in the address recognizing step, a first address for the first network and a second address for the first network which are not in use in the second network,
an address determining step of determining whether the first address and the second address are in use in the second network and a third network connected to the second network via a router,
a first address setting step of setting the first address as an address of the information processing apparatus for the first network when the first address is determined in the address determining step not to be in use,
a second address setting step of assigning the second address to a node on the first network when the second address is determined in the address determining step not to be in use, and
an address converting step of converting an address of a network packet when a node on the first network is to communicate with a node on the second network by using the first address and the second address.
